(19) United States
(12) Patent Application Publication
(10) Pub. No.: US 2006/0151920 A1
(43) Pub. Date: Jul. 13, 2006

(54) Graded particulate compositions

(75) Inventor: Charles William Lawrence, Hobro (DK)

Correspondence Address: BANNER & WITCOFF, 1001 G STREET N W, SUITE 1100, WASHINGTON, DC, 20001, US

(73) Assignee: GC Holding A/S, C/O Composhield A/S, Hobro (DK)

(21) Appl. No.: 10/528,412

(22) PCT Filed: Sep. 23, 2003
(86) PCT No.: PCT/EP03/11064

§ 371 Date: Oct. 6, 2005

(30) Foreign Application Priority Data
Sep. 26, 2002 (GB) 0222344.4

(51) Int. Cl. B06B 1/02; B29C 39/00

(52) U.S. Cl. 264/414; 264/413; 264/443

(57) ABSTRACT

A method of forming a particle mass comprising at least two particle populations arranged in a desired graded relationship, comprising: forming in a container a first layer of dry particles constituting a first particle population having a desired particle size distribution, superimposing on the first layer a second layer of dry particles constituting a second particle population having a desired particle size distribution, the second layer being in direct contact with the first layer at a contact interface, and causing the particle mass in the container to vibrate to cause a desired degree of migration of particles from one or both layers across the contact interface under the influence of force experienced by particles in the mass. The particle populations may have different physical and/or chemical properties, so that the particle mass is functionally graded for subsequent fusion into a functionally graded material such as a ceramic or ceramic/metal composite.

This invention relates to a method for forming a particle mass comprising at least two particle populations arranged in a desired graded relationship. In particular, the particle populations may have different physical and/or chemical properties, so that the particle mass is functionally graded for subsequent fusion into a functionally graded material such as a ceramic or ceramic/metal composite.

### BACKGROUND TO THE INVENTION

Functionally graded materials have physical and/or chemical properties which change in a smooth rather than abrupt or stepwise manner along a vector through the material, usually its thickness, One important class of such materials consists of those which are formed by fusion of a (sometimes compacted) particle mass, such as ceramics and metal/ceramic composites. Functionally graded ceramics or ceramic/metal composites are useful for a large number of applications, including wear parts generally; engine and pump components such as seals, gaskets and valves; cutting tools; drawing and extrusion dies; brake discs; armour; thermal barrier coatings; liquid and gas filters; and specialist instrument and electronic applications.

For fused particle materials, the particle mass is built up by deposition of a thickness of particles whose composition changes during the build up, the changing composition reflecting the changing physical and/or chemical properties required for the desired functional grading of the finished material. Where the material is in the form of a coating, particle build up is sometimes by means of chemical or physical vapour deposition onto the substrate, but these processes are slow, and the range of materials to which they are applicable is limited. Spraying of electrostatically charged particles, as in ink-jet printing methods, is sometimes used for both coatings and shaped articles, but the porosity of the article dr coating is often high and again the range of materials suitable for the process is limited. Where the material is in the form of a moulded article, techniques include
(i) co-fusion of a stacked tape assembly, for example co-sintering of ceramic tapes, the properties of successive tapes in the stack changing to reflect the functional grading desired in the fused article. This process suffers from the disadvantage that the functional property transition from tape to tape is rather abrupt.
(ii) self-propagating high temperature synthesis of layered powders, where a stack of thin layers of particles which are exothermically reactive is caused to fuse by the heat of the reaction, fusing first at the layer interfaces and subsequently in the interior of each layer. Here also the composition of the layers is selected to reflect the functional grading desired in the fused article, but the process suffers from the disadvantages that only a limited choice of exothermically reactive powders is available, and the porosity of the material is often high.
(iii) graded casting, where the thickness of the material is built up by continuously mixing a plurality of different particle slurry compositions and feeding the resultant mixed slurry into a porous mould. The proportions of each slurry being mixed and then dispensed into the mould are varied during mould filling to create the correct mix of particles for the functional property required at that point in the thickness of the material. Liquid is drained from the mould during filling so that the particle mass builds up in the mould as a wet cake. This process suffers from the disadvantages that control over the mixing of particle slurries can be crude, liquid extraction and wet cake drying are time consuming, typically more than 24 hours.

### BRIEF DESCRIPTION OF THE INVENTION

This invention makes available an alternative method for forming a particle mass comprising at least two particle populations arranged in a desired graded relationship, especially those where the particle populations have differing physical and/or chemical properties. The process is based on vibration of a particle mass comprising dry particle layers stacked one on another, the vibration being controlled to cause a desired degree of migration of particles from one layer to another across layer boundaries, such migration being primarily a result of the different migration rates of different particle sizes in the vibrated mass under the influence of forces applied to the particles in the mass, principally gravitational and/or centripetal force, but in some cases also magnetic or electromagnetic forces. Being a dry process, it is conveniently quick. It is applicable to a wide range of potentially useful particle materials, and allows fine control over the arrangement of particles in the resultant graded mass.

### DETAILED DESCRIPTION OF THE INVENTION

The present invention provides a method of forming a particle mass comprising at least two particle populations arranged in a desired graded relationship, the method comprising forming in a container a first layer of dry particles constituting a first particle population having a desired particle size distribution, superimposing on the first layer a second layer of dry particles constituting a second particle population having a desired particle size distribution, the second layer being in direct contact with the first layer at a contact interface, and causing the particle mass in the container to vibrate to cause a desired degree of migration of particles from one or both layers across the contact interface under the influence of force experienced by particles in the mass, for example gravitational and/or centripetal and/or magnetic and/or electromagnetic force.

As used herein the term “particle” refers to a small body of inorganic or organic material having a shortest dimension of from about 5 nm to about 100 μm, and having a longest dimension no greater than about three times that of the shortest dimension. Within those dimensional limits, the shape of a “particle” is irrelevant, and includes generally spheroidal, ellipsoidal, polyhedral and plate-like geometries as well as irregular shapes. “Particles” may be crystalline or amorphous, and may be solid, hollow or otherwise cavitied.

As used herein the term “microfibre” refers to a synthetic polymer or inorganic body which has a length of from about 1 μm to about 1 mm, and whose length is more than ten times its thickness. Often microfibres will have a generally circular, tubular or elliptical cross section and/or blunt ends. Synthetic polymer microfibres may be of, for example, polyethylene, polypropylene and the like, and inorganic microfibres may be of, for example, glass, silicon carbide, alumina, carbon, steel and the like.

As used herein the term “whisker” refers to a body which has a length of from about 1 μm to about 100 μm, and whose length is between three and ten times its thickness. Often whiskers will have a generally circular or polyhedral cross-section and/or sharp ends. Examples of whisker materials include silicon carbide, alumina, boron carbide, tantalum carbide, and niobium carbide.

As used herein the term “dry particles” refers to a particle population which is free flowing under the vibrational conditions of the method of the invention. It does not exclude the presence of small quantities of liquids, providing they are insufficient to prevent such free flow of particles.

Container

The method of the invention is carried out on particle layers in a container. The container may be a mould defining the desired shape of the particle mass, which in turn may define the desired shape of an article created by fusing the particles into a coherent mass. In one embodiment, the base of the mould may be separable from its side walls, so that after the method of the invention is applied to the particle mass in the mould, a particle fusion step also fuses the mass to the base of the mould which then forms part of the fused article. This embodiment may be useful, for example, where the fused particles are to form a coating on a substrate constituted by the mould base.

Friction effects between the wall of the container and the particles may, in some cases, affect the uniformity of particle migration across layer boundaries, for example by reducing the depth of intermixing adjacent the walls relative to that remote from the walls. Where such effects are undesirable for any given application, they may be reduced by use of low friction materials for the container walls and in some cases by appropriate choice of container shape.

Particle Layers

The method of the invention involves forming a stack of layers of dry particles in a container, each in contact with the layer on which it is superimposed at a contact interface.

Particles in a layer may be of more than one particle material. A particle layer may include non-particle components, for example microfibres and/or whiskers. Where more than one particle material is present in a layer, and/or where a layer contains non-particle materials, the components of the layer are preferably pre-blended before forming the layer in the container from the pre-blend.

The particles of each layer are selected to have a desired particle size range. It is presently believed that, for a given particle population under vibration in a gravitational or centripetal field the distance over which a particle migrates is largely determined by its size—i.e. smaller particles migrate over larger distances than larger particles. Other factors such as density and surface effects may also affect the distance over which particles migrate, but such effects are likely to be small when compared with the effect of particle size. Any microfibre and/or whisker materials in a layer are unlikely to migrate to any significant extent compared to particles, since their shape offers greater resistance to movement through the particle matrix of the layer.

With the above principle in mind, the particle size ranges of two contiguous layers can be selected, together with the vibration conditions, to achieve a desired degree of migration of particles from one or both layers, across the contact interface between the layers, so that particles from one or both layers infiltrate the other layer(s) to produce a desired graded arrangement of particles along a vector through the layers in the direction of the gravitational or centripetal force. Where the particles of each layer are selected to have different physical or chemical properties, the effect of the migration across the contact interface between layers is to produce a functionally graded arrangement, where the function is determined by the physical and/or chemical properties of the particles of each layer and mixtures thereof in various proportions.

Functional properties for which particle populations of the layers might be chosen include wear, toughness and/or reinforcement, thermal, electrical, magnetic, chemical resistance, and surface properties.

The particle materials present in any layer may be selected from a wide range of possibilities. Important classes of particle materials are ceramics such as silicon carbide, alumina, silicon nitride, zirconium oxide, boron carbide, boron nitride, and tungsten carbide; metals such as tungsten, boron, steel, and cobalt; and synthetic resin materials such as epoxy, polyester, and phenol-formaldehyde resins.

Multiple Layers

The simplest particle layer stack to which the method of the invention may be applied consists of two particle layers. However, the method is also applicable in cases where more than two layers are required to construct the eventual desired size-graded particle mass or fused article. In such cases one or more additional dry particle layers is/are successively stacked on the second or a subsequent layer of the stack, each additional layer (like the first and second layers) comprising dry particles which constitute a particle population having a desired particle size distribution, and (again like the first and second layers) each additional layer being in direct contact at a contact interface with the layer on which it is superimposed, and the particle mass is vibrated after completion of, or at intervals during the assembly of the stack to cause a desired degree of migration of particles across one or more of the contact interfaces under the influence of force such as gravitational, centripetal, magnetic or electromagnetic force. For example, where the intended graded particle mass is to be constructed from four layers of particles,
all four layers might be stacked and then vibrated; or
the first two layers might be assembled and vibrated and the other two layers might then be successively stacked on the particle mass formed by the first two layers, before vibrating the whole assembly; or
the first two layers might be assembled and vibrated, the third layer stacked on the particle mass formed by the first two layers, then vibrated, and the fourth layer stacked on the particle mass formed by the first three layers, then vibrated.
   Vibration and Compaction

The method of the invention requires that the particle mass in the container be vibrated to cause a desired degree of migration of particles across the contact interface(s) between layers under the influence of force experienced by particles in the mass, for example gravitational and/or centripetal and/or magnetic and/or electromagnetic force. Usually the force applied to the particles will be unidirectional, along the grading vector through the mass, normally its thickness. In most cases, the particle layers will be stacked generally horizontally, so that vibration takes place under the influence of gravity. However, it is also feasible to assemble the stacked particle layers at a substantial angle to the horizontal or even vertically, by for example spinning or rotating the assembly as the layers are created, so that centripetal force is applied through the thickness of the stack as the stack during layer assembly and during vibration. For example, where the desired graded particle mass is to be in the form of a cylinder, a first layer of particles might be formed by injecting the particles into a cylindrical mould while spinning the mould about its longitudinal axis. Centripetal force then spreads the particles as a cylindrical layer on the interior surface of the mould. A second particle population might then be injected into the mould while it is still spinning, to form a second cylindrical particle layer superimposed on, and in contact with the first. The mould might then be vibrated while spinning, to cause the desired particle migration across the contact interface between layers. In cases where one or more of the particle layers contains metal or electrically conductive particles, it may be advantageous to influence these particles during vibration by the application of a magnetic or electromagnetic field to the particle mass.

Whether it takes place under gravitational, centripetal or other force, the amplitude, frequency and duration of the vibration will be tailored to the required degree of intermingling of particles required in the desired graded particle mass. Because the method of the invention is quite generally applicable to a wide range of particle size populations, with or without additives such as microfibres and whiskers, for the production of a wide range of fused articles, it is not possible to specify universally preferable combinations of ranges for those parameters. Some general comments may however be made: Vibration of particle populations can produce two effects, increased particle packing density and fluidisation, which decreases packing density. In most cases, particles introduced into a container for treatment in accordance with the invention will not initially be packed at the highest potential packing density. Vibration of non-optimally packed particles can increase the packing density. In general, for any given particle population vibrated at a given frequency, a smaller vibrational amplitude (the parameter which controls the acceleration to which the particles are subjected) is required to increase packing density than to produce fluidisation. Since the migration of particles across layer boundaries mainly occurs while the particles are fluidised, vibration in accordance with the invention should preferably include a period when the frequency and amplitude are chosen to produce fluidisation. This does not rule out a period of vibration where the frequency and amplitude are chosen to increase packing density, either before or (especially) after the fluidisation vibration.

However, for typical ceramic or metal ceramic composites, it will often be the case that for fluidisation the frequency of vibration will be in the range 50-2000 Hz, for example 50-500 Hz, such as 75-150 Hz (about 100 Hz ofteen being appropriate for particle populations with a mean particle size of about 1 micometer), and the amplitude will be in the range 1 μm to 10 mm. The duration of vibration will often be of the order of from a few seconds to a few minutes, in many cases, one or two minutes.

Vibration of the particle mass in the container may be indirect, by vibration of the container itself, or direct, by vibration of probes inserted into the mass to be vibrated. In very specialised instances, it may be desirable to cause the particle mass to vibrate by placing the container containing the mass in an ultrasound field.

The particle layers being treated in accordance with the invention may be pressure compacted, during and/or after vibration. During the fluidisation phase of the vibration, light pressure compaction, for example by means of a plate in contact with the top layer of a layer stack, may be beneficial in controlling particle dust clouds thrown off by the fluidisation. Of course, any such pressure compaction during the fluidisation vibration may increase the inter particle friction (increase locking stress between particles), making it necessary to increase amplitude (acceleration) to achieve fluidisation and cross-boundary mixing. In general it may be more convenient to operate at lower amplitudes for safety reasons, so pressure compaction during the fluidisation vibration should preferably be low.

Fusion

In many cases, the method of the invention will be applied for the production of coherent, monolithic articles or coatings formed by fusion of the graded particle mass. Such fusion will in many cases involve sintering or melting the particles of the mass by heating. This will be the case for ceramic, metal, or ceramic/metal composite articles. However, some articles may be fused by chemical reaction, such as by cross-linking or other chemical bonding between synthetic polymer particles, for example in the case of liquid or gas filters formed from bonded polymer particles, whose size (and thus the filter pore size), or whose size and adsorbency, varies along the flow path through the filter.

1. A method of forming a particle mass comprising at least two particle populations arranged in a desired graded relationship, the method comprising:
forming in a container a first layer of dry particles constituting a first particle population having a desired particle size distribution,
superimposing on the first layer a second layer of dry particles constituting a second particle population having a desired particle size distribution,
the second layer being in direct contact with the first layer at a contact interface, and
causing the particle mass in the container to vibrate to cause a desired degree of migration of particles from one or both layers across the contact interface under the influence of force experienced by particles in the mass.

2. A method as claimed in claim 1 wherein the particle mass in the container is caused to vibrate under the influence of gravitational force, centripetal force, magnetic electromagnetic force, or combinations thereof.

3. A method as claimed in claim 1 wherein the particle mass is caused to vibrate by vibrating the container.

4. A method as claimed in claim 1 wherein one or more additional dry particle layers is/are successively stacked on the second or a subsequent layer of the stack,
each additional layer comprising dry particles constituting a particle population having a desired particle size distribution,
each additional layer being in direct contact at a contact interface with the layer on which it is superimposed, and
the particle mass is vibrated after completion of, or at intervals during the assembly of the stack to cause a desired degree of migration of particles across one or more of the contact interfaces under the influence of gravitational, centripetal force or other applied forces.

5. A method as claimed in claim 1 wherein one or more layer of particles also contains whiskers, microfibres, or combinations thereof.

6. A method as claimed in claim 1 wherein at least two particle layers in direct contact at a contact interface comprise particle populations which are selected such that the population of one layer has a desired set physical properties, chemical properties, or both different from that of the population of the other layer.

7. A method as claimed in claim 1 wherein the container containing the particle layers is a mould defining the desired shape of the particle mass.

8. A method as claimed in claim 1 wherein the particle mass in the container is pressure compacted during or after the vibration step.

9. A method as claimed in claim 1 wherein at least one particle layer comprises ceramic particles.

10. A method as claimed in claim 1 wherein at least one particle layer comprises metal particles.

11. A method as claimed in claim 1 wherein at least one particle layer comprises polymer particles.

12. A method as claimed in claim 1 wherein a particle layer comprising ceramic particles is superimposed at a contact interface on a particle layer comprising metal particles or vice versa.

13. A method as claimed in claim 1 wherein at least one particle layer is prepared by pre-blending the components thereof prior to forming the layer in the container.

14. A method as claimed in claim 1 wherein after the vibration step the particle mass is fused into a coherent article.

15. An article obtained by the method of claim 14.
